(19) United States
(12) Patent Application Publication
(10) Pub. No.: US 2022/0191976 A1
(43) Pub. Date: Jun. 16, 2022

(54) COOKING APPLIANCE

(71) Applicant: BSH Hausgeräte GmbH, Munich (DE)

(72) Inventors: Tomas Cabeza Gozalo, Zaragoza (ES); Alberto Dominguez Vicente, Zaragoza (ES); Sergio Llorente Gil, Zaragoza (ES); Jesus Manuel Moya Nogues, Zaragoza (ES); Antonio Muñoz Fumanal, Utebo (ES); Ramon Peinado Adiego, Zaragoza (ES); Jorge Villa Lopez, Jaca (Huesca) (ES)

(21) Appl. No.: 17/436,091

(22) PCT Filed: May 8, 2020
(86) PCT No.: PCT/EP2020/062833

§ 371 Date: Sep. 3, 2021

(30) Foreign Application Priority Data
May 10, 2020 (EP) 19382362

(51) Int. Cl. H05B 6/06

(52) U.S. Cl. CPC H05B 6/062; H05B 2213/05

(57) ABSTRACT

A cooking appliance device includes a control and/or regulating unit provided to repetitively control a first induction target with a first heating current frequency in a periodic continuous heating operating state, which is allocated an operating period, to supply the first induction target with energy, and to operate the first induction target in a switched-on interval of the operating period with a heating power. The control and/or regulating unit is provided to select in the continuous heating operating state a sum of all switched-on intervals of the operating period as a multiple of a reciprocal value of the first heating current frequency.

The invention relates to a cooking appliance device according to the preamble of claim 1 and a method for an operation of a cooking appliance device according to the preamble of claim 12.

The prior art already discloses cooking appliance devices and in particular hobs that have inductors that are operated over temporally averaged switched-on sequences and switched-off sequences in order to heat different items of cookware with a heating power that is below a technically limited lower threshold value for the heating power, wherein, as a consequence of increased customer requirements with regard to noise pollution and cooking temperatures for example, complex control schemes are drawn upon so as to control inductors in order to heat items of cookware, which hampers compliance with flicker standards and EMC standards and in turn results in an increase in complexity of the control scheme.

The publication U.S. Pat. No. 8,686,321B2 discloses in this context a method for operating an induction cooking device, wherein one or multiple items of cookware is supplied an average electrical power that is set by an operator, wherein the items of cookware are operated with an optimal control sequence that is selected from a plurality of preset pattern sequences in order to achieve the selected electrical power, wherein the optimal control sequence is selected with regard to the operator specifications and in the case of multiple possible pattern sequences in addition with regard to the energy consumption.

The publication EP1951003B1 discloses a method for simultaneous activation of two inductors of an induction hob, wherein each induction heating appliance is connected to an alternating current inverter for the independent regulation of the prevailing heating power that is supplied by each inductor to a cooking utensil that is arranged on said inductor, wherein the alternating current inverters are controlled during a predetermined operating period with periodic signals that can be set in a similar manner to a switched-on interval, wherein the switched-on interval is synchronized with a supply voltage and is embodied as multiples of 10 ms.

The object of the invention is in particular to provide a cooking appliance device of the generic type having improved characteristics with regard to a control. The object is achieved in accordance with the invention by the features of claims 1 and 12 while advantageous embodiments and developments of the invention are apparent in the dependent claims.

The invention is based on a cooking appliance device, in particular an induction hob device, having a control and/or regulating unit that is provided so as in at least one periodic continuous heating operating state, which is allocated at least one operating period, to repetitively control at least one induction target with a heating current frequency and so as to supply said induction target with energy and so as to operate the induction target in at least one switched-on interval of the operating period with a heating power, in particular a desired heating power or an excess power with respect to a desired heating power.

It is proposed that the control and/or regulating unit is provided so as in the continuous heating operating state to select a sum of all the switched-on intervals of the operating period as a multiple of a reciprocal value of the heating current frequency, in particular as a multiple of 10 μs to 50 μs.

It is preferred that the control and/or regulating unit selects in the continuous heating operating state a sum of all the switched-on intervals of the operating period as a multiple of at least 10 μs. It is preferred that the control and/or regulating unit selects in the continuous heating operating state a sum of all the switched-on intervals of the operating period as a multiple of maximum 50 μs.

It is possible by the embodiment in accordance with the invention to provide a cooking appliance device of the generic type having improved characteristics with regard to an in particular simplified control and in particular a more precise realization of desired heating powers and in particular an improved conformity to flicker standards and in particular with regard to an operation with a low noise level. An advantageously precisely defined average heating power can be achieved owing to shortened switched-on intervals. In particular, it is possible to realize a reliable embodiment preferably in reference to a desired heating power that is requested by the operator. In particular, it is possible to achieve that an average heating power in a period of time that is known from the prior art for the operating period such as for example 10 ms advantageously corresponds precisely to a desired heating power that is requested by the operator. It is advantageously possible as a consequence to prevent intermittent cooking. In particular, it is advantageously possible to achieve melting procedures of chocolate. It is preferred that flickers at least to a large extent can be avoided, in particular essentially entirely avoided, according to a flicker standard, in particular according to DIN EN 61000-3-3-standard and/or the IEC standard 1000-3-3, in particular by an advantageous control of individual or multiple induction targets. Furthermore, it is in particular possible to avoid an operator being subjected to a disadvantageous acoustic loading whereby in particular it is possible to achieve a high degree of operator comfort and also in particular to provide the operator with a positive impression in particular with regard to an acoustic quality. It is possible by a simplified control to significantly reduce in particular an outlay for finding realizable control schemes during operation of multiple induction targets. As a consequence, it is possible to embody an advantageously energy-saving cooking appliance device, in particular by the use of more cost-effective and/or lower power components. Advantageously, it is possible to reduce outlay that uses an increasing number of induction targets for the control of a desired heating power that is requested by an operator. In particular, it is advantageously possible for multiple induction targets to be operated jointly simultaneously with an advantageously precise desired heating power with an advantageously low noise level and with a flicker-controlled load of a supply network. In a particularly advantageous manner it is possible to achieve that the cooking appliance device avoids a maximum power requirement above 4.25 kW, preferably above 3.7 kW or equivalent 16 Aᵣₘₛ. As a consequence, it is advantageously possible to avoid power failures or it is possible to avoid having to switch off the cooking appliance device for safety reasons. It is particularly advantageously possible to embody a quiet cooking appliance device that, as it were, embodies controlled frequency groups without it being necessary to adhere to Flicker conditions. It is advantageously possible to achieve discrete switched-on intervals. As a consequence, it is possible to embody advantageous, in particular advantageously short, operating periods. As a consequence, it is possible to advantageously avoid low frequency mains current variations.

The term a “cooking appliance device”, advantageously an “induction hob device” is to be understood in particular to mean at least a part, in particular a subassembly of a cooking appliance, in particular of an oven, for example of an induction oven, and advantageously of a hob and particularly advantageously an induction hob. Advantageously, the household appliance that has a cooking appliance device is a cooking appliance. A household appliance that is embodied as a cooking appliance could be for example an oven and/or a microwave and/or a grilling appliance and/or a steam cooking appliance. Advantageously, a household appliance that is embodied as a cooking appliance is a hob and preferably an induction hob.

The term a “control and/or regulating unit” is to be understood in particular to mean an electronic unit that is preferably at least in part integrated into a cooking appliance device, in particular an induction hob device, and that in particular is provided so as to control and/or regulate at least one inverter unit of the cooking appliance device having at least one inverter, in particular a resonance inverter and/or a dual half bridge inverter. In particular, the control and/or regulating unit evaluates a signal that is provided by a unit, in particular by a sensor and/or detecting unit, whereby the control and/or regulating unit, in particular in the case of fulfilling at least one condition, can initiate a specific procedure and/or operating state. It is preferred that the control and/or regulating unit comprises a computing unit and in particular in addition to the computing unit a storage unit having a control and/or regulating program that is stored therein and said control and regulating program is provided so as to be implemented by the computing unit.

In particular, the cooking appliance device can have a switching unit that is embodied in particular as a semiconductor switching element, in particular as a transistor. In particular, the switching unit is controlled and/or regulated by the control and/or regulating unit, wherein the switching unit produces in particular an electrical connection between at least one energy source and at least one energy consumer, for example one of the induction targets. The switching unit can have in particular at least one switching element that is electromechanical or semiconductor-based and can be provided so as to produce at least one electrical connection at least between the at least one energy source and at least the one induction target. The term a “switching element” is to be understood in particular to mean an element that is provided so as to produce and/or interrupt an electrically conductive connection between two points, in particular contacts of the switching element. It is preferred that the switching element has at least one control contact via which it is possible to connect the switching element. In particular, the switching element is embodied as a semiconductor switching element, in particular as a transistor, for example as a metal oxide semiconductor field effect transistor (MOSFET) or organic field effect transistor (OFET), advantageously as a bipolar transistor having preferably insulated gate electrode (IGBT). Alternatively, the switching element is embodied as a mechanical and/or electromechanical switching element, in particular as a relay.

The term an “induction target” is to be understood in particular to mean an inductor or a plurality of inductors that is/are in particular part of the cooking appliance device and have an item of cookware that is placed over the inductor and/or over the plurality of inductors, wherein the inductor or the plurality of inductors are provided in particular together in at least one in particular specific operating state, in particular in at least one continuous heating operating state so as to inductively heat the item of cookware that is placed over the inductor or over the plurality of inductors. In this case, the inductors of the induction target can provide in each case an identical heating power in comparison to one another in at least the continuous heating operating state. Advantageously, the control and/or regulating unit controls the inductors of an induction target with an identical heating current frequency. Moreover, the inductor, in particular precisely one individual inductor, of the induction target can provide a different heating power for a time period during at least the continuous heating operating state. The control and/or regulating unit is in particular provided so as to define at least one induction target. In particular, the control and/or regulating unit can define multiple induction targets. The cooking appliance device has in particular at least one inductor, in particular a plurality of inductors. The term an “inductor” is to be understood here in particular to mean an element that in at least one continuous heating operating state supplies at least one item of cookware with energy, in particular in the form of a magnetic alternating field, for the purpose of heating the item of cookware, and said alternating field is provided so as to produce eddy currents and/or remagnetization effects in a metallic, preferably at least in part ferromagnetic heating means, in particular an item of cookware, and said eddy currents and/or remagnetization effects are converted into heat. The inductor has in particular at least one induction coil and is in particular provided so as to supply energy in the form of a magnetic alternating field at a heating current frequency to the item of cookware.

The term a “heating current frequency” is understood in particular to mean a frequency of an electrical alternating current in a range of 20 kHz-100 kHz, preferably 30 kHz-75 kHz, which is applied to an inductor in order to generate a magnetic alternating field. The inductor is arranged in particular below and advantageously in an immediate vicinity of at least one resting plate of the cooking appliance. In particular, the plurality of inductors can be arranged in the manner of a matrix, wherein the inductors that are arranged the manner of a matrix can form a variable cooking surface. In particular, it is possible to combine the inductors with one another to arbitrarily large induction targets, in particular having different contours. Alternatively or in addition thereto, it is possible for the inductors to also be arranged in the form of a classic cooking mirror, in particular having two, three, four or five, heating zones that are highlighted in particular with respect to the rest of the surface of the resting plate that is embodied as a matrix hob.

The expression “to supply an object with energy” is to be understood in particular as providing an electrical energy in the form of an electrical voltage, an electrical current and/or an electrical and/or electromagnetic field of at least one energy source for the object. The term an “energy source” is to be understood in particular to mean a unit that provides an electrical energy in the form of an electrical voltage, an electrical current and/or an electrical and/or electromagnetic field of at least one further unit and/or at least one electrical current circuit. The energy source can be in particular an electrical current phase of a current supply network. In particular, by way of a regulating unit, the energy source can provide a maximum power of 3.7 kW or can be limited to a maximum power output of 3.7 kW. Advantageously, it is possible to arrange an inverter unit between the energy source and at least one induction target, preferably all the induction targets, so as to provide a high frequency supply voltage at a suitable heating current frequency. The energy source can also have in particular an inverter unit. In particular, the inverter unit can have at least one, in particular at least two or also more inverters, so as to provide a high frequency voltage at a suitable heating current frequency for induction targets. In particular, a heating current frequency is different from the frequency of a supply voltage. It is preferred that the control and/or regulating unit is provided so as to select and/or to set the heating current frequency in a range of 20 kHz-100 kHz, preferably 30 kHz-75 kHz. In particular, each induction target has a dedicated maximum frequency at which said induction target can be operated. The maximum frequency of an induction target depends upon the construction type, the components and other technical limitations. For example, the maximum frequency of an induction target can amount to 75 kHz or 100 kHz. An induction target that is operated at its maximum frequency generates a minimum possible heating power, in particular output heating power, in particular during the switched-on time of said induction target, in particular during the switched-on intervals of said induction target. The term an “output heating power” of an induction target is understood in particular to mean an electrical power that the inductor of the at least one induction target provides to an item of cookware of the at least one induction target for heating in at least one time interval, in particular at least one switched-on interval, of the operating period of the continuous heating operating state.

The term a “continuous heating operating state” is to be understood in particular to mean an operating state that is embodied differently from a frequency sweep state and in which a specific control of a unit, in particular of at least one induction target, in particular of at least two induction targets, is performed so as to achieve a desired heating power over the duration of the state and/or the control and/or regulating unit is provided so as to apply a specific method and/or a specific algorithm to the unit, in particular to the induction targets so as to achieve a desired heating power over the duration of the state, wherein in particular the control and/or regulating unit operates the at least one, in particular the at least two induction targets in a coordinated manner. In particular, the continuous heating operating state lasts, in particular for an uninterrupted period of time, at least 10 ms, preferably at least 1 s, advantageously at least 60 s and particularly preferably at least 300 s, wherein the control and/or regulating unit is provided so as to supply electrical energy in the form of an output heating power in particular to at least one induction target, in particular by means of the applied heating current frequency, wherein the output heating power is advantageously unequal to 0, in particular greater than 0 and in particular corresponds in a temporal average to a desired heating power. In particular, a temperature increase of an item of cookware of the induction target and/or a temperature increase and/or an at least in part phase transition of an item of food to be cooked that is located in the item of cookware takes place in the continuous heating operating state. In particular, the temperature increase of the item of cookware and/or the item of food to be cooked amounts to in particular at least 0.5° C., advantageously at least 1° C., preferably at least 5° C. and particularly advantageously at least 10° C. In particular, a mass proportion of the food to be cooked that experiences a phase transition amounts to at least 1%, advantageously at least 5%, preferably at least 10% and particularly advantageously at least 20%. In particular, the continuous heating operating state is embodied differently from a frequency sweep state. The term a “frequency sweep state” is to be understood to mean a state in which the control and/or regulating unit is provided so as to record and/or measure and store a frequency spectrum that is available for at least one induction target and in each case heating powers, in particular output heating powers, that are achieved are associated with said frequency spectrum.

In the continuous heating operating state, the control and/or regulating unit adjusts in particular at least one output heating power of the at least one induction target, advantageously at least a large portion of the output heating power of the at least one induction target and preferably all output heating powers of the at least one induction target by means of a heating current frequency and/or by means of mutually phase-shifted control signals and/or by means of a duty cycle.

The term a “repetitive control” of a unit or the term “to repetitively control” a unit is to be understood here in particular to mean a periodically repeating control of a unit in the at least one continuous heating operating state, in particular by way of an electrical signal. The induction target is preferably repetitively controlled in the continuous heating operating state with the operating period. It is preferred that the control and/or regulating unit repeats the control out of an individual operating period at least of one induction target within an individual continuous heating operating state, in particular until this continuous heating operating state is terminated by an operator input. In particular, the operating period in particular the control of the induction targets of an operating period is repeated over the entire duration of the continuous heating operating state.

The term an “operating period” is to be understood in particular to mean a time period during which the control and/or regulating unit is provided so as to operate the induction target in a continuous heating operating state. In particular, the induction target is activated during the operating period, wherein the induction target can be supplied with electrical energy, wherein the electrical energy can be insignificantly small. It is preferred that the control and/or regulating unit is provided so as to supply and/or operate the induction target within an operating period of the continuous heating operating state with an average electrical power. The term an “average electrical power” is to be understood in particular to mean an electrical power that is supplied averaged over a time period, in particular over an operating period, in particular to the induction target. It is preferred that the average electrical power corresponds to a desired heating power that is set in particular by the operator. The term a “desired heating power” is to be understood to mean the power that is desired by an operator and is to be supplied to an induction target at least in the temporal middle of the continuous heating operating state. In particular, a desired heating power can also be a zero heating power. The term a “zero heating power” is to be understood to mean an insignificantly low power. It is preferred that each different operator input of a desired heating power leads to a different continuous heating operating state, in particular to a different control of the at least one induction target in the operating period of the continuous heating operating state.

The term an “excess power” of an induction target is to be understood in particular to mean a power whose average value in relation to a time interval of the operating period exceeds the average power, in particular desired heating power, of the induction target within an operating period of the continuous heating operating state. In particular, the control and/or regulating unit is provided so as to achieve the excess power by applying an electromagnetic alternating field at a heating current frequency that is different from a target frequency.

The term “target frequency” is to be understood to mean a heating current frequency that in an operation of the at least one induction target achieves at each point in time a desired heating power that is required and/or set by the operator in the induction target. In particular, the excess power can be achieved during an operation of the hob device in a ZVS mode at a heating current frequency that is lower than the target frequency. In particular, the excess power can be achieved during an operation of the hob device in a ZCS mode at a heating current frequency that is higher than the target frequency. The term a “ZVS mode” is to be understood to mean in particular a zero voltage switching mode in which during a switching procedure of a switching element a voltage that has a value of approx. equal to zero is applied. The term a “ZCS mode” is to be understood to mean in particular a zero current switching mode in which during a switching procedure of a switching element a current that has a value of approx. equal to zero is applied. In particular, the heating current frequencies are selected by the control and/or regulating unit in such a manner that the heating current frequencies do not generate any intermodulation interfering signals which are acoustically perceivable by human beings with an average hearing ability. In particular, the intermodulation interfering signals arise by coupling at least two heating current frequencies that have a frequency spacing with respect to one another of less than 20 kHz in particular less than 17 kHz.

The term a “power deficit” is to be understood in particular to mean a power whose average value in relation to a time interval is below the average power of an induction target. In particular, the power deficit can be achieved by applying an electromagnetic alternating field at a heating current frequency that is different from a target frequency, wherein during an operation of the induction target at the target frequency a power is provided that is required and/or set by the operator. In particular, the power deficit is achievable during an operation of the hob device in a ZVS mode at a heating current frequency that is higher than the target frequency. In particular, the power deficit can be achieved during an operation of the hob device in a ZCS mode at a heating current frequency that is lower than the target frequency.

The term “provided” is to be understood in particular to mean especially programmed, designed and/or equipped. This term is also to be understood to mean that an object is provided so as to perform a specific function and that the object fulfills and/or performs this specific function in at least one application state and/or operating state and/or in a continuous heating operating state.

The operating period has at least one time interval, in particular switched-on interval in which the control and/or regulating unit operates the induction target at a heating current frequency, in particular in order to achieve an output heating power, in particular a desired heating power, in the at least one induction target. The operating period can have at least one time interval, in particular switched-off interval, in which the induction target is operated without a heating current frequency, in particular so as to achieve a zero heating power in the at least one induction target. In particular, the operating period can be divided into at least two time intervals during which the control and/or regulating unit operates the induction target at a constant heating current frequency, in particular supplies said induction target with a constant electrical energy. The term a “time interval” is understood to mean in particular a time period, the duration of which is longer than 0 s and shorter than or identically as long as the operating period. A sum, in particular a duration of the sum, of all the time intervals of the operating periods of individual induction targets corresponds precisely to a duration of the operating period of the respective induction target. In particular, it is possible for individual time intervals to have different durations to one another. The control and/or regulating unit is in particular provided in the continuous heating operating state so as to select each switched-on interval in each operating period as a multiple of the reciprocal value of the heating current frequency, in particular a multiple of 10 μs to 50 μs. The control and/or regulating unit preferably selects in the continuous heating operating state each time interval, in particular switched-on interval and/or switched-off interval, in each operating period as a multiple of the reciprocal value of the heating current frequency, in particular a multiple of 10 μs to 50 μs. It is preferred that the control and/or regulating unit is provided so as in the continuous heating operating state to repetitively cycle through the operating periods for at least one induction target in the absence of an amended desired heating power that is set by an operator. It is preferred that the at least one switched-on interval of an induction target is determined via the following equation:

tₒₙ=P_{SOLL}/(P_{AUS}−f_{HS}),

wherein P_{SOLL} is the desired heating power that is to be achieved in the case of an induction target averaged over the operating period and P_{AUS} is the output heating power of an induction target in the case of a heating current frequency (f_{HS}) that is applied. The output heating power can correspond for example to a minimum heating power P_{MIN} of an induction target if the control and/or regulating unit operates the respective induction target at its maximum frequency (f_{MAX}). The control and/or regulating unit is provided in the continuous heating operating state in particular so as to determine the target frequency for the induction target, in particular from a desired heating power that is set by the operator. It is preferred that the control and/or regulating unit in the continuous heating operating state determines the target frequency for the induction target, in particular from a desired heating power that is set by the operator. In the continuous heating operating state, the control and/or regulating unit is in particular provided so as to match the target frequency with a maximum possible frequency, in particular a maximum frequency, of the at least one induction target. It is preferred that in the continuous heating operating state the control and/or regulating unit matches the target frequency with a maximum possible frequency, in particular the maximum frequency, of the at least one induction target. If the maximum frequency is higher than the determined target frequency, the control and/or regulating unit is in particular provided so as in the continuous heating operating state to select the at least one switched-on interval that is identical to the operating period. It is preferred that in the continuous heating operating state the control and/or regulating unit selects the at least one switched-on interval that is identical to the operating period if the maximum frequency is higher than the determined target frequency.

If the maximum frequency is lower than the determined target frequency, the control and/or regulating unit is in particular provided so as in the continuous heating operating state to operate the induction target at its maximum frequency in the at least one switched-on interval of an operating period and so as to operate the induction target without a frequency in the switched-off interval of the same operating period so as to achieve the desired heating power averaged over the operating period. It is preferred that in the continuous heating operating state, the control and/or regulating unit operates the induction target at its maximum frequency in the switched-on interval of an operating period and operates the induction target without a frequency in the switched-off interval of the same operating period in order to achieve the desired heating power averaged over the operating period if the maximum frequency is lower than the determined target frequency. Independent of the target frequency, the control and/or regulating unit is in particular provided so as in the continuous heating operating state to select the at least one switched-on interval as a multiple of the reciprocal value of the heating current frequency, in particular the maximum frequency of the induction target that is controlled. It is preferred that the control and/or regulating unit in the continuous heating operating state selects the switched-on interval as a multiple of the reciprocal value of the heating current frequency independent of the target frequency, in particular of the maximum frequency of the induction target that is controlled. It is preferred that the control and/or regulating unit in the continuous heating operating state selects a sum of all the switched-on intervals independent of the target frequency, in particular of an individual induction target, of the operating period as a multiple of a reciprocal value of the heating current frequency.

Moreover, it is proposed that the sum of all the switched-on intervals of the operating period, in particular of an individual induction target, corresponds to maximum half of a period duration of an alternating voltage supply, in particular a mains alternating voltage, in particular maximum 10 ms or 8.67 ms. The term a “alternating voltage supply” is to be understood to mean in particular the 50 Hz, in particular 60 Hz, alternating voltage from the current supply network. The control and/or regulating unit is in particular provided so as in the continuous heating operating state to select the sum of all the switched-on intervals, in particular of an individual induction target, within an individual operating period maximum as half of a period duration of an alternating voltage supply, in particular a mains alternating voltage, in particular maximum 10 ms or 8.67 ms. The control and/or regulating unit is in particular provided so as in the continuous heating operating state to select the sum of all the switched-on intervals and switched-off intervals, in particular of an individual induction target, within an individual operating period maximum as half of a period duration of an alternating voltage supply, in particular mains alternating voltage. As a consequence, an advantageous average energy consumption or an advantageous average heating power can be achieved within an/each operating period.

Moreover, it is proposed that the operating period corresponds to maximum half of a period duration of an alternating voltage supply, in particular a mains alternating voltage, in particular maximum 10 ms or 8.67 ms. As a consequence, it is possible to achieve an advantageous average energy consumption or an average heating power within an operating period, wherein particularly advantageously it is possible, in particular as a direct result, to maintain flicker standards that are to be maintained between the respective halves of a period duration of an alternating voltage supply, in particular mains alternating voltage.

Furthermore, it is proposed that the operating period corresponds to an integer factor of half of a period duration of an alternating voltage supply. It is preferred that the operating period is embodied as a factor of the half of the period duration of the alternating voltage supply that fulfils the following equation:

n=T_{HNETZ}/T_{BP},

wherein n is the integer factor, T_{HNETZ} is the half of the period duration of the alternating voltage supply and T_{BP} is the operating period. It is preferred that n is at least 2. It is preferred that n is maximum 100, preferably maximum 50 and particularly preferably maximum 10. As a consequence, it is advantageously possible to cycle through multiple operating periods within the half of the period duration of the alternating voltage supply, in particular the period duration of a rectified alternating voltage supply. As a consequence, it is possible to achieve a particularly advantageous input of energy into an item of cookware, in particular a cooking procedure.

Furthermore, it is proposed that the control and/or regulating unit is provided so as in the continuous heating operating state to operate the induction target in at least one further switched-on interval of the operating period with a heating power, in particular a desired heating power or an excess power with respect to a desired heating power. As a consequence, it is possible to achieve an advantageous distribution of heating energy that is introduced in particular in the case of operating periods above 10 ms. As a consequence, it is possible to achieve an advantageously precise temporal distribution of a cooking temperature in an item of cookware.

Furthermore, it is proposed that the control and/or regulating unit is provided so as in the continuous heating operating state to operate, in particular continuously, at least one further induction target during the operating period. It is preferred that the control and/or regulating unit is provided so as to operate the further induction target in at least one switched-on interval at least of one operating period with a heating current frequency in order to achieve a heating power, in particular a desired heating power. As a consequence, it is advantageously possible to provide a cooking environment that ensures a particularly advantageous average heating power, in particular a set desired heating power in at least two items of cookware. It is possible in particular to provide a cooking environment that can contain the desired heating power that is requested by an operator and set in at least two items of cookware in an advantageously precise manner and over an advantageously long period of time.

Moreover, it is proposed that the control and/or regulating unit is provided so as in the continuous heating operating state to operate at least one inverter of the cooking appliance device per induction target. An inverter unit of the cooking appliance device having at least one inverter is advantageously arranged between the energy source and each induction target in order to provide a high frequency supply voltage at a suitable heating current frequency. As a consequence, it is advantageously possible to achieve that the cooking appliance device, in particular control and/or regulating unit, can operate each induction target with a precise desired heating power independent of the number of induction targets.

Furthermore, it is proposed that the control and/or regulating unit is provided so as in the continuous heating operating state to measure a heating power of the induction target at least twice within a half of a period duration of an alternating voltage supply. The control and/or regulating unit is in particular provided so as to measure the heating power, in particular output heating power, in at least two operating periods, in particular in each operating period, within the half of the period duration of the alternating voltage supply. It is preferred that the control and/or regulating unit is provided so as to store the measured heating powers in a vector format with precisely as many inputs as operating periods in each half of the period duration of the alternating voltage supply. It is preferred that the control and/or regulating unit is provided so as in the continuous heating operating state to measure and to store an output heating power of all the induction targets at at least one target frequency. Advantageously, it is consequently possible to achieve a calculating procedure in order to embody energy-saving switched-on intervals for each induction target, in particular in the case that multiple induction targets are operated at the same heating current frequency, in particular by the same inverter.

Furthermore, it is proposed that the control and/or regulating unit is provided so as in the continuous heating operating state to repetitively control at least one second induction target with a second heating current frequency and so as to supply said second induction target with energy and so as to operate the second induction target in at least one second switched-on interval of the operating period with a heating power, in particular a desired heating power or an excess power with respect to a desired heating power, wherein the second heating current frequency either essentially equals the heating current frequency or differs from the heating current frequency by at least 16 kHz, in particular by at least 20 kHz, and, wherein the control and/or regulating unit is in particular provided so as in the continuous heating operating state to select a sum of all the second switched-on intervals of the operating period as a multiple of a reciprocal value of the second heating current frequency. The control and/or regulating unit is in particular provided so as in the continuous heating operating state to determine the target frequencies and/or the output heating powers at the target frequencies of all the induction targets, in particular in order to achieve the desired heating power of said induction targets averaged over the operating period. The control and/or regulating unit is in particular provided so as in the continuous heating operating state to determine whether multiple induction targets can be controlled at the same target frequency, in particular by a single inverter in order to avoid intermodulation noise. In particular, the control and/or regulating unit is provided so as in the continuous heating operating state to operate induction targets, the target frequencies of said induction targets differing from one another by less than 20 kHz, preferably less than 17 kHz, particularly preferably less than 16 kHz, at the same heating current frequency, wherein the heating current frequency corresponds in particular to the lowest target frequency of the induction targets that are to be controlled together. In particular, the control and/or regulating unit is provided so as in the continuous heating operating state either to control all the induction targets at the same heating current frequency and/or all the induction targets at heating current frequencies that differ by at least 20 kHz, preferably at least 17 kHz, particularly preferably at least 16 kHz, wherein it is possible to control multiple induction targets at the same heating current frequency as a group. The control and/or regulating unit is in particular provided so as in the continuous heating operating state to determine the output heating power of the induction targets that are controlled at the same heating current frequency. The control and/or regulating unit is in particular provided so as in the continuous heating operating state to select the switched-on intervals of the induction targets as a multiple of the reciprocal value of the respective heating current frequency of said induction targets in order to achieve the desired heating power averaged over the operating period. As a consequence, it is possible to achieve in at least two items of cookware an advantageous noise load while simultaneously advantageously maintaining precise conformity to a specific cooking temperature and advantageously conforming to flicker standards.

Moreover, it is proposed that the control and/or regulating unit is provided so as in the continuous heating operating state to divide the switched-on interval of the induction target in the operating period, in particular in at least a half of a period duration of an alternating voltage supply, in particular mains alternating voltage, into at least two switched-on intervals that are separated by at least one switched-off interval in which the induction target is operated with a power deficit with respect to a desired heating power, preferably without power. A first switched-on interval is preferably separated from a further switched-on interval by a switched-off interval, wherein the at least one switched-off interval, the switched-on interval and the further switched-on interval are embodied within the same operating period. It is preferred that the at least three time intervals, in particular the one switched-off interval, the switched-on interval and the further switched-on interval, are embodied within one operating period. It is preferred that multiple switched-on intervals and multiple switched-off intervals are distributed alternately in order to achieve an average heating power, in particular a desired heating power, over the complete operating period. As a consequence, it is possible to achieve that an effect of high frequency changes within the half of the period duration of the alternating voltage supply, in particular the period duration of a rectified alternating voltage supply, lie within the EMC standards.

Furthermore, a cooking appliance, in particular an induction hob, having at least one cooking appliance device is proposed. As a consequence, it is possible to achieve an advantageous cooking procedure that conforms to flicker standards. In addition, a low noise level cooking procedure can be rendered possible. As a consequence, it is possible in particular to advantageously maintain a precise cooking temperature, in particular in the case of long cooking procedures and low desired temperatures, for example in the case of melting chocolate.

The invention is moreover based on a method for operating a cooking appliance device, in particular an induction hob device, wherein in at least one periodic continuous heating operating state, which is allocated at least one operating period, at least one induction target is repetitively controlled with a heating current frequency and is supplied with energy and the induction target is operated in at least one switched-on interval of the operating period with a heating power, in particular a desired heating power or an excess power with respect to a desired heating power.

It is proposed that in the continuous heating step a sum of all the switched-on intervals of the operating period is selected as a multiple of a reciprocal value of the heating current frequency.

As a consequence, it is possible to achieve an advantageous cooking environment whilst advantageously conforming to flicker standards.

The cooking appliance device in this case is not to be limited to the above-described application and embodiment. In particular, the cooking appliance device can have a number of individual elements, components and units that deviates from any number being defined herein, in order to fulfil a function described herein.

Further advantages are provided in the following description of the drawing. An exemplary embodiment of the invention is illustrated in the drawing. The drawing, the description and the claims contain numerous features in combination. The person skilled in the art will also expediently consider the features individually and will combine said features to useful further combinations.

In the drawings:

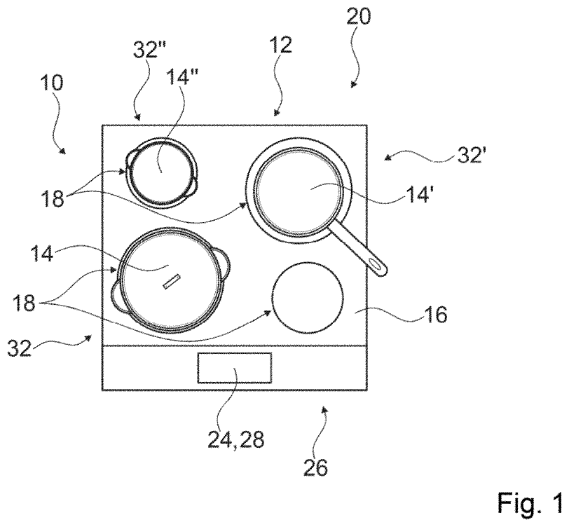

FIG. 1 shows a hob having a cooking appliance device and in an exemplary manner items of cookware that are placed thereon,

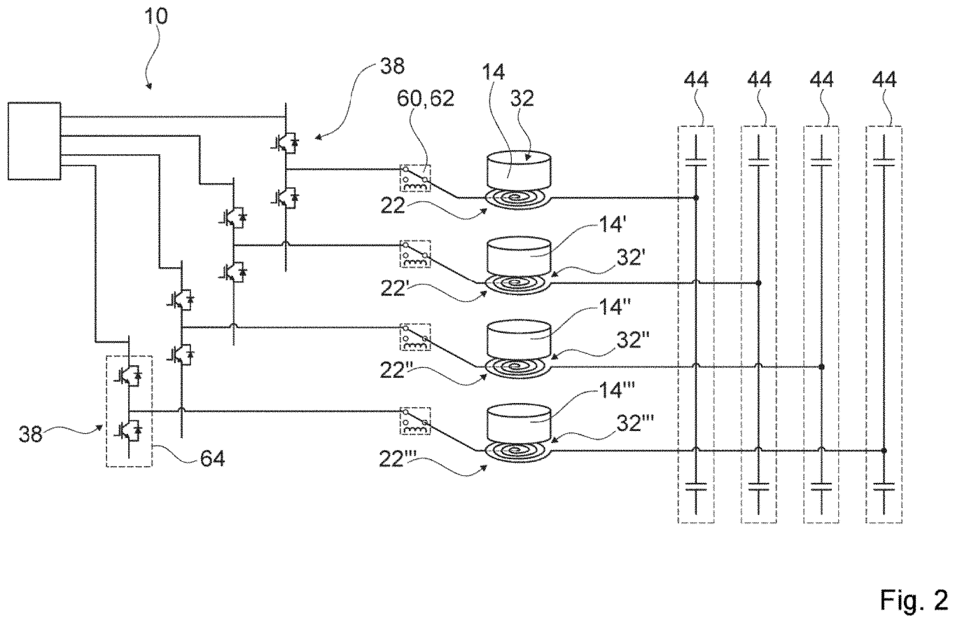

FIG. 2 shows the cooking appliance device having four induction targets that are defined by a control and/or regulating unit,

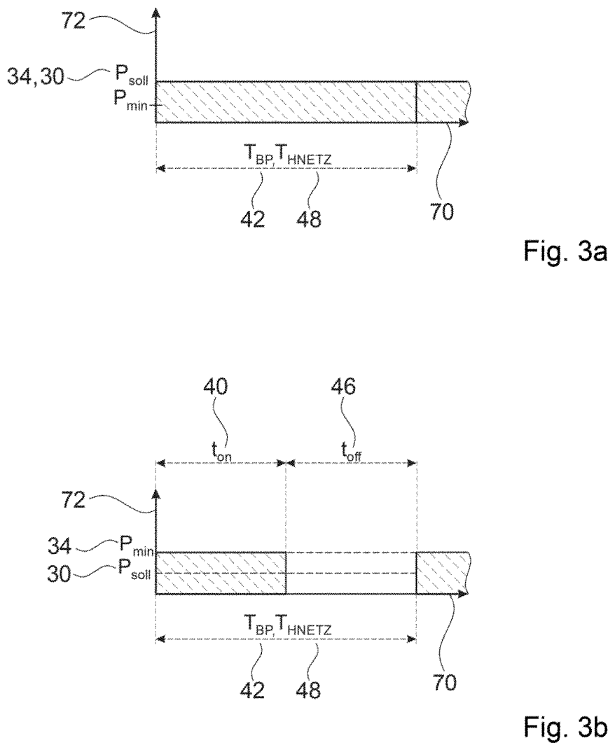

FIG. 3 shows a schematic illustration of a control for one of the induction targets,

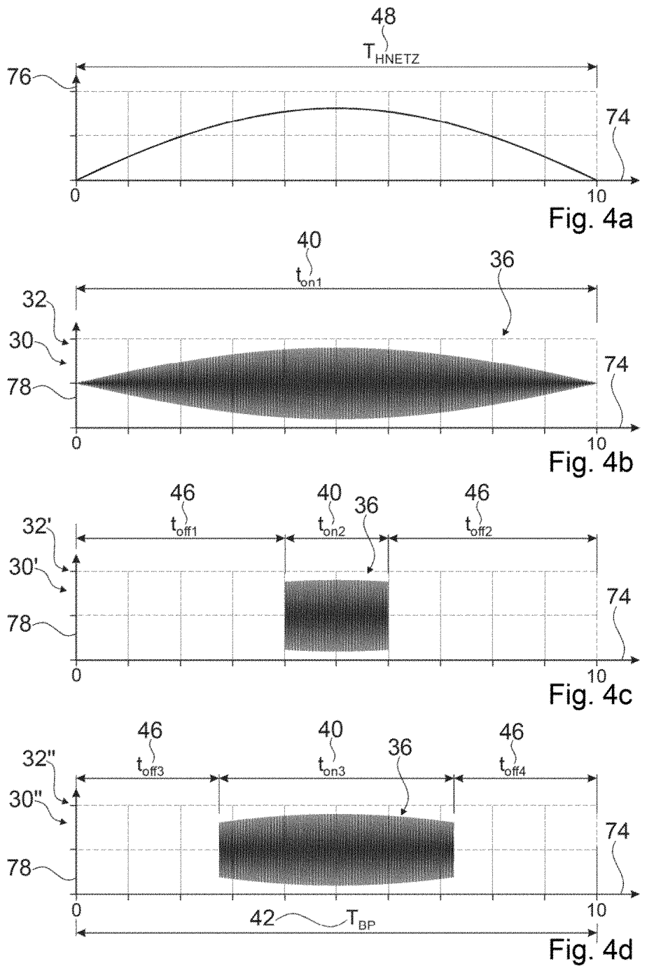

FIG. 4 shows a schematic illustration of a control for three of the induction targets,

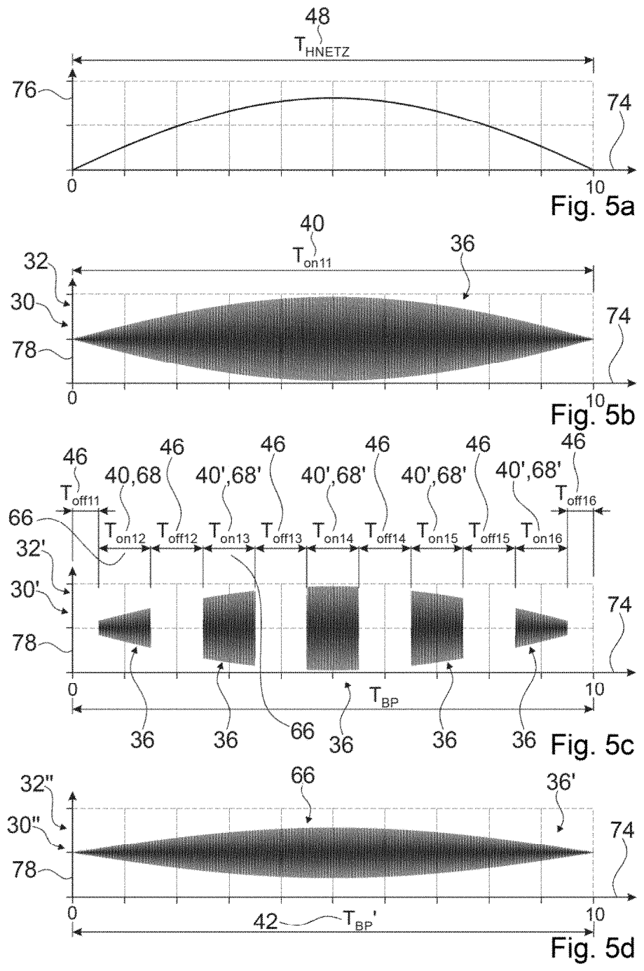

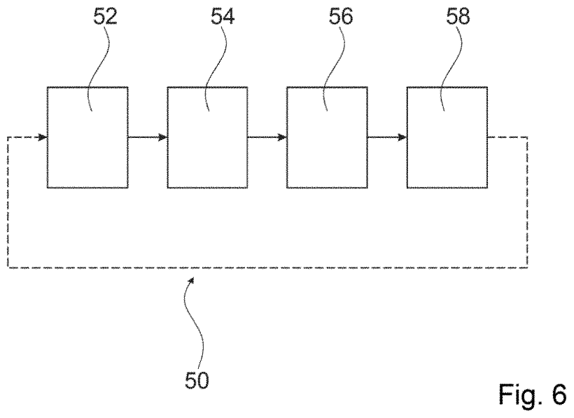

FIG. 5 shows a schematic illustration of a further control for three of the induction targets and

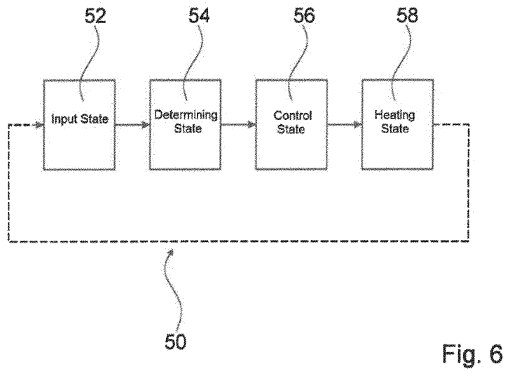

FIG. 6 shows a schematic illustration of a method for operating the cooking appliance device.

In the figures, in part only one instance of the objects that are provided multiple times is provided with a reference character.

FIG. 1 illustrates a cooking appliance 20 that is embodied as a hob 12, in particular as an induction hob, and three items of cookware 14, 14′, 14″ that are placed on said induction hob.

The cooking appliance 20 has a resting plate 16. The resting plate 16 is provided for the placement of items of cookware 14, 14′, 14″. The resting plate 16 is embodied as a hob plate. In the illustrated exemplary embodiment, the cooking appliance 20 has four classic cooking zones 18. It is however alternatively also feasible that the cooking appliance 20 is embodied as a matrix hob. In each case an item of cookware 14, 14′, 14″ is arranged on three of the four cooking zones 18.

The cooking appliance 20 has a cooking appliance device 10 that is embodied as an induction hob device.

The cooking appliance device 10 has a plurality of inductors 22, 22′, 22″, 22′″. FIG. 2 illustrates in an exemplary manner a cooking appliance device 10 having in each case one inductor 22, 22′, 22″, 22′″ per cooking zone 18 or item of cookware 14, 14′, 14″, 14′. An inductor 22, 22′, 22″, 22′″ is allocated precisely to one cooking zone 18. It is conceivable that in the case of a matrix hob, the inductors 22, 22′, 22″, 22′″ are arranged in the manner of a matrix below the resting plate 16 in order to embody a uniform cooking zone 18. It is likewise conceivable that in the case of a matrix hob, multiple inductors 22, 22′, 22″, 22′ are arranged in individual regions of the resting plate 16 in order to embody various cooking zones such as for example rapid cooking zones, wherein it is furthermore possible by virtue of the matrix hob to utilize the full surface of the resting plate 16 for cooking. In the current example, the cooking appliance device 10 has four inductors 22, 22′, 22″, 22′.

The inductors 22, 22′, 22″, 22′″ are arranged in the installed state below the resting plate 16, in particular within the cooking appliance device 10. The inductors 22, 22′, 22″, 22′ are in each case in particular provided so as in a periodic continuous heating operating state 50 to heat, in particular in an inductive manner, an item of cookware 14, 14′, 14″, 14′″ that is arranged on the resting plate 16 and is placed over the inductors 22, 22′, 22″, 22′″.

The cooking appliance device 10 has a control panel 24 for inputting and/or selecting operating parameters by an operator. For example, an operating parameter can be embodied as a desired heating power 30, 30′, 30″ and/or a cooking duration, wherein the operating parameter can be set in particular as a discrete and/or abstract value for example in quantized intervals or from a pool of an essentially continuous value range. The control panel 24 is embodied as a display 28, in particular a touchscreen display. The control panel 24 is provided so as to output the at least one operating parameter to the operator.

The cooking appliance device 10 has a control and/or regulating unit 26. The control and/or regulating unit 26 is in particular provided so as to implement programs, actions and/or algorithms and/or so as to change settings of the cooking appliance device 10 in dependence upon the operating parameters that are input by an operator, such as the desired heating power 30, 30′, 30″ or a cooking duration.

Based on the item of cookware 14, 14′, 14″, 14′″ that is placed on the resting plate 16, the control and/or regulating unit 26 defines in this case for example multiple induction targets 32, 32′, 32″, 32″″. In FIG. 1, two induction targets 32, 32′ are defined by the control and/or regulating unit 26 based on the items of cookware 14, 14′ that are placed on the resting plate 16 and the inductors 22, 22′ that are arranged below the resting plate 16. In FIG. 2, four induction targets 32, 32′, 32″, 32′″ are defined by the control and/or regulating unit 26. One induction target 32, 32′, 32″, 32′″ has precisely one inductor 22, 22′, 22″, 22′″. One induction target 32, 32′, 32″, 32′″ has at least one item of cookware 14, 14′, 14″, 14′″. The control and/or regulating unit 26 can define a plurality of induction targets 32, 32′, 32″, 32′″ in particular in dependence upon the embodiment of the hob 12 and the items of cookware 14, 14′, 14″, 14′″ that are located on said hob.

The control and/or regulating unit 26 heats an item of cookware 14, 14′, 14″, 14′″ by applying a heating current frequency 36 to the respective inductor 22, 22′, 22″, 22′″. An output power 34 that is achieved in particular for a moment of one of each induction target 32, 32′, 32″, 32′″ is largely dependent upon the heating current frequency 36 that is applied at the induction target 32, 32′, 32″, 32′″. In a ZVS mode, the output heating power 34 of an induction target 32, 32′, 32″, 32′″ increases with decreasing heating current frequency 36. In a ZCS mode, the output heating power 34 of an induction target 32, 32′, 32″, 32′″ decreases with decreasing heating current frequency 36. The control and/or regulating unit 26 operates the cooking appliance device 10 in an exemplary manner in the ZVS mode.

In the continuous heating operating state 50, an energy source supplies the induction targets 32, 32′, 32″, 32′″ with electrical energy. The energy source is an electrical current phase of a current supply network. The cooking appliance device 10 comprises at least one inverter unit 38 for providing at least one heating current frequency 36 for the respective induction target 32, 32′, 32″, 32′″ (cf. FIG. 2).

FIG. 2 illustrates the cooking appliance device 10 with four of the induction targets 32, 32′, 32″, 32′″ that are defined by the control and/or regulating unit 26 of the cooking appliance device 10. The cooking appliance device 10 has four resonant inverter units 38. The inverter units 38 provide the heating current frequency 36 for the induction targets 32, 32′, 32″, 32′″. The inverter units 38 supply the induction targets 32, 32′, 32″, 32′″ with electrical energy independent of one another. Each inverter unit 38 is in each case allocated to one of the induction targets 32, 32′, 32″, 32′″. Each inverter unit 38 comprises an inverter 64 in FIG. 2 in an exemplary manner.

The control and/or regulating unit 26 is provided so as in the periodic continuous heating operating state 50, which is allocated an operating period 42, to repetitively control and supply energy to the at least one induction target 32, 32′, in particular from the energy source. The control and/or regulating unit 26 is provided in the continuous heating operating state 50 so as to periodically control and supply energy to the induction targets 32, 32′. The control and/or regulating unit 26 is in particular provided so as to operate the induction target 32, 32′, 32″, 32′″ in a switched-on interval 40 of the operating period 42 with a heating power, in particular a desired heating power 30, 30′, 30″ or an excess power with respect to the desired heating power 30, 30′, 30″. The control and/or regulating unit 26 in the continuous heating operating state 50 repetitively cycles through the operating period 42 for at least one induction target 32, 32′, 32″, 32′″ in particular in the absence of an amended desired heating power 30, 30′, 30″ that is set by an operator.

The cooking appliance device 10 has one electromechanical switch element 60 per induction target 32, 32′, 32″, 32′″. The switch element 60 is embodied as a relay 62. The induction targets 32, 32′, 32″, 32′″ can be connected by the relay 62 to the electrical energy supply. The cooking appliance device 10 has in each case one resonance capacitor unit 44 per induction target 32, 32′, 32″, 32′″. Each induction target 32, 32′, 32″, 32′ can be controlled individually at a respective heating current frequency 36.

FIG. 3 illustrates a ZVS mode control of the control and/or regulating unit 26 for the case that an operator has input a desired heating power 30, 30′, 30″ for a single induction target 32, 32′, 32″, 32′″. In the case of the control of an individual induction target 32, 32′, 32″, 32′″, the control and/or regulating unit 26 in the continuous heating operating state 50 determines the target frequency for the induction target 32, 32′, 32″, 32′″, in particular from the desired heating power 30, 30′, 30″ that is set by the operator. In the case of the control of an individual induction target 32, 32′, 32″, 32′″, in the continuous heating operating state 50 the control and/or regulating unit 26 matches the target frequency with a maximum possible frequency, in particular a maximum frequency, of the at least one induction target 32, 32′, 32″, 32′″. FIGS. 3a and 3b in each case illustrate a diagram that illustrates the temporal curve of the heating power of an induction target 32, 32′, 32″, 32′ over an operating period 42 of different continuous heating operating states 50. The time in seconds is plotted on the abscissa 70 and the power in watts is plotted on the ordinate 72 (cf. FIGS. 3a and 3b). The time in seconds is plotted on the abscissa 70 in the FIGS. 3a and 3b. The power in watts is plotted on the ordinate 72 in the FIGS. 3a and 3b.

FIG. 3a illustrates the case that the maximum frequency is higher than the determined target frequency for the induction target 32, 32′, 32″, 32′. If the maximum frequency is higher than the determined target frequency, the control and/or regulating unit 26 in the continuous heating operating state 50 selects the switched-on interval 40 as identical to the operating period 42 in order to provide the desired heating power 30, 30′, 30″ that is set in each operating period 42. If the maximum frequency is higher than the determined target frequency, the control and/or regulating unit 26 in the continuous heating operating state 50 selects the switched-on interval 40 as a multiple of the reciprocal value of the heating current frequency 36 that is applied, in particular of the target frequency of the induction target 32, 32′, 32″, 32′ that is controlled.

FIG. 3b illustrates the case that the maximum frequency is lower than the determined target frequency for the induction target 32, 32′, 32″, 32′″. If the maximum frequency is lower than the determined target frequency, the control and/or regulating unit 26 in the continuous heating operating state 50 operates the induction target 32, 32′, 32″, 32′″ in the switched-on interval 40, tₒₙ of an operating period 42 at the maximum frequency of said induction target. If the maximum frequency is lower than the determined target frequency, the control and/or regulating unit 26 in the continuous heating operating state 50 operates the induction target 32, 32′, 32″, 32′″ without a frequency in a switched-off interval 46, t_{off}, in particular of the same operating period 42, in order to achieve the desired heating power 30, 30′, 30″ in the middle during the operating period 42. If the maximum frequency is lower than the determined target frequency, the control and/or regulating unit 26 in the continuous heating operating state 50 selects the switched-on interval 40 as a multiple of the reciprocal value of the heating current frequency 36, in particular of the maximum frequency of the induction target 32, 32′, 32″, 32′″ that is controlled. FIG. 3b illustrates that the selected switched-off interval 46 and the selected switched-on interval 40 have the same duration, in particular half of the duration of the operating period 42. Depending upon the form of the maximum frequency of an induction target 32, 32′, 32″, 32′″ and the desired heating power 30, 30′, 30″ that is set and also the selected duration of the operating period 42, the control and/or regulating unit 26 varies the duration of the switched-on and switched-off intervals 40, 46 with respect to one another, in particular in order to achieve the requested desired heating power 30, 30′, 30″ during each operating period of the continuous heating operating state 50.

FIGS. 3a and 3b illustrate that the control and/or regulating unit 26 in the continuous heating operating state 50 selects the operating period 42 precisely as half of a period duration of an alternating voltage supply 48, T_{HNETZ}. In both, in particular in the cases illustrated by the FIGS. 3a and 3b, the sum of all the switched-on intervals 40 corresponds to maximum half of the period duration of the alternating voltage supply 48, T_{HNETZ}, in particular mains alternating voltage. In both, in particular in the cases that are illustrated in the FIGS. 3a and 3b, the operating period 42 corresponds to maximum half of the period duration of the alternating voltage supply 48, T_{HNETZ}, in particular mains alternating voltage. It is conceivable in both cases that the operating period 42 corresponds to an integer factor of half of the period duration of the alternating voltage supply 48, T_{HNETZ}. In both cases, the control and/or regulating unit 26 selects each switched-on interval 40 in each operating period 42 of the continuous heating operating state 50 as a multiple of the reciprocal value of the heating current 36 that is applied at the respective induction target 32, 32′, 32″, 32′″, in particular a multiple of 10 μs to 50 μs. In both cases, the control and/or regulating unit 26 selects each time interval, in particular switched-on interval 40, 40′ and/or switched-off interval 46 in each operating period 42 as a multiple of the reciprocal value of the heating current frequency 36 that is applied, in particular a multiple of 10 μs to 50 μs. A conformity to flicker standards is checked after each half of the period duration of the alternating voltage supply 48, T_{HNETZ}. A flicker is permitted in a controlled manner by the control and/or regulating unit 26 by the formation of the operating period 42 as an integer factor of half of the period duration of the alternating voltage supply 48, T_{HNETZ}. It is possible to avoid a maximum power requirement of over 4.25 kW, preferably of over 3.7 kW, over a time limit of one of the halves of the period duration of the alternating voltage supply 48, T_{HNETZ} by the formation of the operating period 42 as an integer factor of the half of the period duration of the alternating voltage supply 48.

FIG. 4 illustrates a ZVS mode control for induction targets 32, 32′, 32″, 32′″ by the control and/or regulating unit 26 for the case that an operator has input a desired heating power 30, 30′, 30″ for three induction targets 32, 32′, 32″. The time in milliseconds is plotted on the abscissa 74 in the FIGS. 4a to 4d. The voltage in volts is plotted on the ordinate 76 in FIG. 4a. The current strength in amps is plotted on the ordinate 78 in the FIGS. 4b to 4d.

FIG. 4a illustrates the rectified temporal curve of the alternating voltage supply. The time in milliseconds is plotted on the abscissa 74 and the voltage in volts is plotted on the ordinate 76. The FIGS. 4b to 4c illustrate the temporal curve of the prevailing current at the inductors of the respective controlled induction targets 32, 32′, 32″. The time in milliseconds is plotted on the abscissa 74 and the current strength in amps is plotted on the ordinate 78.

The FIGS. 4 a to 4d illustrate the case that the control and/or regulating unit 26 in the continuous heating operating state 50 operates three of the induction targets 32, 32′, 32″, 32′″ while avoiding intermodulation interfering signals. The control and/or regulating unit 26 is in particular provided so as in the continuous heating operating state 50 to measure a heating power, in particular output heating power 34, of the induction target 32, 32′, 32″ at least twice within the half of the period duration of the alternating voltage supply 48. The control and/or regulating unit 26 is in particular provided so as in the continuous heating operating state 50 to repetitively control at least one second induction target 32′ with a second heating current frequency 36′ and so as to supply said second induction target with energy. The control and/or regulating unit 26 is in particular provided so as in the continuous heating operating state 50 to operate the first induction target 32 in the switched-on interval 40, tₒₙ₁ of the operating period 42 with a heating power, in particular the desired heating power 30, P_{SOLL}. The control and/or regulating unit 26 is in particular provided so as in the continuous heating operating state 50 to operate the second and third induction target 32′, 32″ in at least one second, in particular one third, switched-on interval 66, tong, tₒₙ₂, tₒₙ₃ of the operating period 42 with a heating power, in particular an excess power with respect to the desired heating power 30′, 30″, P_{SOLL}. The second heating current frequency 36′ matches either essentially the heating current frequency 36 or differs from the heating current frequency 36 by at least 16 kHz, in particular by at least 20 kHz. In the illustrated example, the control and/or regulating unit 26 operates all three induction targets 32, 32′, 32″ with the same heating current frequency 36 of 55 kHz. The control and/or regulating unit 26 is in particular provided so as in the continuous heating operating state 50 to select a sum of all the second switched-on intervals 66 of the operating period 42 as a multiple of a reciprocal value of the second heating current frequency 36′.

In order to avoid intermodulation interfering signals, the control and/or regulating unit 26 determines the target frequencies for each induction target 32, 32′, 32″ that is to be controlled.

The first induction target 32 has for example a target frequency of 55 kHz. The target frequencies of the second and third induction target 32′, 32″ differ by less than 16 kHz, in particular less than 20 kHz, from the target frequency of the first induction target 32.

The control and/or regulating unit 26 in the continuous heating operating state 50 operates the three induction targets 32, 32′, 32″, whose target frequencies differ from one another by less than 16 kHz, in particular less than 20 kHz, with the same heating current frequency 36, wherein the heating current frequency 36 corresponds in particular to the lowest target frequency of all the, in particular three, induction targets 32, 32′, 32″ that are controlled together. The control and/or regulating unit 26 controls all the induction targets 32, 32′, 32″ with the same heating current frequency 36, in this example 55 kHz, in particular in order to avoid intermodulation interfering signals.

The control and/or regulating unit 26 in the continuous heating operating state 50 operates the three induction targets 32, 32′, 32″ periodically in each case over an entire cooking duration. The cooking duration is divided into operating periods 42. In the continuous heating operating state 50, the control and/or regulating unit 26 sets output powers of the three induction targets 32, 32′, 32″ over the respective heating current frequency 36. The operating period 42 has three switched-on intervals 40, tₒₙ₁, tₒₙ₂, tₒₙ₃ (cf. FIGS. 4b, 4c, 4d).

The control and/or regulating unit 26 in the continuous heating operating state 50 operates the first induction target 32 in all the switched-on intervals 40, tₒₙ₁, tₒₙ₂, tₒₙ₃ of the operating period 42 with the desired heating power 30, P_{SOLL} of the first induction target 32 (cf. FIG. 4b), in particular above the target frequency of for example 55 kHz.

The control and/or regulating unit 26 in the continuous heating operating state 50 operates the second induction target 32′ in a first time interval t_{off1}, in particular the switched-off interval 46, of the operating period 42 with a power deficit, in particular with a zero heating power (cf. FIG. 4c). The control and/or regulating unit 26 operates the second induction target 32′ in a second time interval tₒₙ₂ of the operating period 42 with an excess power with respect to the desired heating power 30′, P_{SOLL} of the second induction target 32′. The control and/or regulating unit 26 operates the second induction target 32′ in a third time interval tₒₙ₃, in particular the switched-off interval 46, of the operating period 42 with a power deficit, in particular a zero heating power, with respect to the desired heating power 30′ P_{SOLL} of the second induction target 32′. The control and/or regulating unit 26 operates the second induction target 32′ in precisely one time interval tₒₙ with an excess power with respect to the desired heating power 30′, P_{SOLL} that is in particular requested by the operator. The control and/or regulating unit 26 operates the second induction target 32′ in two time intervals t_{off1}, t_{off2} with a zero heating power, in other words without an applied heating current frequency 36 that is different from 0, in particular with a zero heating power.

The control and/or regulating unit 26 in the continuous heating operating state 50 operates the third induction target 32″ in a first time interval t_{off3}, in particular the switched-off interval 46, of the operating period 42 with a power deficit, in particular with a zero heating power, in other words operated without a heating current frequency 36 that is different from 0 (cf. FIG. 4d). The control and/or regulating unit 26 operates the third induction target 32″ in a second time interval tₒₙ₃ of the operating period 42 with an excess power with respect to the desired heating power 30″, P_{SOLL} of the second induction target 32″, in particular at the determined target frequency of the first induction target 32. The control and/or regulating unit 26 operates the third induction target 32′ in a third time interval t_{off4} of the operating period 42 with a power deficit, in particular a zero heating power, with respect to the desired heating power 30″, P_{SOLL} of the third induction target 32″. The control and/or regulating unit 26 operates the third induction target 32″ in precisely one time interval tₒₙ₃ with an excess power with respect to the desired heating power 30″, P_{SOLL} that is in particular requested by the operator. The control and/or regulating unit 26 operates the second induction target 32′ in two time intervals t_{off3}, t_{off4} with a zero heating power, in other words without an applied heating current frequency 36 that is different from 0, in particular with a zero heating power.

The control of the three induction targets 32, 32′, 32″ provides the desired heating power 30, 30′, 30″ at each induction target 32, 32′, 32″ for each induction target 32, 32′, 32″ averaged over the operating period 42. The operating period 42 corresponds to maximum half of the period duration of an alternating voltage supply 48, T_{HNETZ}, in particular mains alternating voltage. The operating period 42 is identical in this example to half of the period duration of the alternating voltage supply 48, T_{HNETZ}. Half of the period duration of the alternating voltage supply 48, T_{HNETZ} is illustrated in an exemplary manner in FIG. 4a. The control and/or regulating unit 26 is in particular provided so as in the continuous heating operating state 50 to select a sum of all the switched-on intervals 40 of the operating period 42, in particular for the three induction targets 32, 32′, 32″ as a multiple of a reciprocal value of the heating current frequency 36, in particular that is respectively applied and in this example identical for all the induction targets.

The sum of all the switched-on intervals 40, in particular of a single induction target 32, 32′, 32″, of the operating period 42 corresponds to maximum half of a period duration of an alternating voltage supply 48, T_{HNETZ}, in particular to mains alternating voltage.

It is conceivable that the operating period 42 corresponds to an integer factor of half of the period duration of the alternating voltage supply 48, T_{HNETZ}.

It is also conceivable that each induction target 32, 32′, 32″, 32′″ is to be and/or must be controlled in the continuous heating operating state 50 with another heating current frequency 36. In particular in that case, the control and/or regulating unit 26 is provided so as in the continuous heating operating state 50 to operate at least one inverter 64 per induction target 32, 32′, 32″, 32′″.

A flicker is checked by the control and/or regulating unit 26 by the formation of the operating period 42 as an integer factor of half of the period duration of the alternating voltage supply 48, T_{HNETZ} and by the formation of switched-off intervals 46 at the beginning and end of each operating period 42. In particular, a flicker is checked by the control and/or regulating unit 26 because the same power level is achieved at each beginning and end of an operating period 42, in particular summed over all the induction targets. It is possible by the formation of the operating period 42 as an integer factor of half of the period duration of the alternating voltage supply 48, T_{HNETZ} to avoid a maximum power requirement of above 4.25 kW, in particular of above 3.7 kW, at the start and/or end of half of the period duration of the alternating voltage supply 48, T_{HNETZ}.

FIG. 5 illustrates the case that the control and/or regulating unit 26 in the continuous heating operating state 50 operates three of the induction targets 32, 32′, 32″, 32′″ while avoiding intermodulation interfering signals. In FIGS. 5a to 5d, the time in milliseconds is plotted on the abscissa 74. In FIG. 5a, the voltage in volts is plotted on the ordinate 76. In the FIGS. 5b to 5d, the current strength in amps is plotted on the ordinate 78.

The rectified temporal curve of the alternating voltage supply is illustrated in FIG. 5a. The time in milliseconds is plotted on the abscissa 74 and the voltage in volts is plotted on the ordinate 76. The FIGS. 5b to 5c illustrate the temporal curve of the current that is applied to the inductors of the respectively controlled induction targets 32, 32′, 32″. The time in milliseconds is plotted on the abscissa 74 and the current strength in amps is plotted on the ordinate 78.

In order to avoid intermodulation interfering signals, the control and/or regulating unit 26 determines the target frequencies for each of the three induction targets 32, 32′, 32″ that are to be controlled.

The first induction target 32 for example has a target frequency of 50 kHz. The target frequency of the second induction target 32′ differs from the target frequency of the first induction target 32 by less than 16 kHz, in particular less than 20 kHz. The target frequency of the third induction target 32″ differs from the target frequency of the first induction target 32 by at least 20 kHz. The target frequency of the second induction target 32′ is lower than the target frequency of the third induction target 32″.

The control and/or regulating unit 26 in the continuous heating operating state 50 operates two of the three induction targets 32, 32′, whose target frequencies differ from one another by less than 16 kHz, in particular less than 20 kHz, with the same heating current frequency 36, wherein the heating current frequency 36 corresponds in particular to the lowest target frequency of all the, in particular of the two, induction targets 32, 32′ that are controlled together. The control and/or regulating unit 26 controls two of the three induction targets 32, 32′ with the same heating current frequency 36, in this example 50 kHz, and the third induction target 32″ with another heating current frequency 36, in this example 70 kHz, in particular in order to avoid intermodulation interfering signals.

The control and/or regulating unit 26 in the continuous heating operating state 50 operates the three induction targets 32, 32′, 32″ in each case periodically over an entire cooking duration. The cooking duration is divided into, in particular repeating, operating periods 42. In the continuous heating operating state 50, the control and/or regulating unit 26 sets output powers of the three induction targets 32, 32′, 32″ above a respective heating current frequency 36. The operating period 42 has different time intervals tₒₙ₁₂, tₒₙ₁₃, tₒₙ₁₄, tₒₙ₁₅, tₒₙ₁₆, t_{off1l}, t_{off12}, t_{off13}, t_{off14}, t_{off15}, t_{off16}, in particular the switched-on intervals 40, 40′ and switched-off intervals 46 and/or switched-on part intervals 68 (cf. FIGS. 5b-d).

The control and/or regulating unit 26 in the continuous heating operating state 50 operates the first induction target 32 in the time interval tₒₙ₁₁ of the operating period 42 with the desired heating power 30, P_{SOLL}, in particular target frequency, of the first induction target 32 (cf. FIG. 5b).

The control and/or regulating unit 26 in the continuous heating operating state 50 operates the second induction target 32′ in a first time interval t_{off11}, in particular switched-off interval 46, of the operating period 42 with a power deficit, in particular with a zero heating power (cf. FIG. 5c). The control and/or regulating unit 26 operates the second induction target 32′ in a second time interval tₒₙ₁₂, of the operating period 42 with an excess power with respect to the desired heating power 30′, P_{SOLL} of the second induction target 32′. The control and/or regulating unit 26 operates the second induction target 32′ in a third time interval t_{off12} of the operating period 42 with a power deficit, in particular a zero heating power, with respect to the desired heating power 30′, P_{SOLL} of the second induction target 32′. The control and/or regulating unit 26 is in particular provided so as in the continuous heating operating state 50 to operate the induction target 32′ in at least one further switched-on interval 40′, tₒₙ₁₃, tₒₙ₁₄, tₒₙ₁₅, tₒₙ₁₆ of the operating period 42, T_{BP} with a heating power, in particular a desired heating power 30′ or an excess power with respect to the desired heating power 30′, P_{SOLL}. The control and/or regulating unit 26 in the continuous heating operating state 50 operates the second induction target 32′ in the switched-on interval 40, tₒₙ₁₂, tₒₙ₁₃, tₒₙ₁₄, tₒₙ₁₅, tₒₙ₁₆ of the operating period 42, T_{BP} with a heating power, in particular a desired heating power 30′ or an excess power with respect to a desired heating power 30′, P_{SOLL}. The control and/or regulating unit 26 operates the second induction target 32′ in precisely five time intervals tₒₙ₁₂, tₒₙ₁₃, tₒₙ₁₄, tₒₙ₁₅, tₒₙ₁₆ with an excess power. The control and/or regulating unit 26 operates the second induction target 32′ in six time intervals t_{off11}, t_{off12}, t_{off13}, t_{off14}, t_{off15}, t_{off16} with a zero heating power, in other words without an applied heating power 36 that is different from 0, in particular with a zero heating power. Alternatively, the control and/or regulating unit 26 can operate the second induction target 32′ in a similar manner to the exemplary embodiment in accordance with FIG. 4 in only one time interval with a heating power, in particular the desired heating power 30′ or an excess power with respect to the desired heating power 30′, P_{SOLL}. The control and/or regulating unit 26 is provided in this exemplary embodiment in particular so as in the continuous heating operating state 50 to divide the switched-on interval 40 of the second induction target 32′ into at least one of the at least one operating periods 42, in particular in at least half of the period duration of the alternating voltage supply 48, in particular mains alternating voltage, into at least two switched-on part intervals 68, 68′ that are separated by at least one switched-off interval 46 in which the corresponding induction target 32′ is operated with a power deficit with respect to a desired heating power 30′, in particular without power. The control and/or regulating unit 26 achieves an advantageous conformity to EMC standards by virtue of the distribution of the switched-on intervals 40, 40′ of the second induction target 32′ over the entire operating period 42 (cf. FIG. 5c).

The control and/or regulating unit 26 is in particular provided so as in the continuous heating operating state 50 to continuously operate at least one further induction target 32, 32′, 32″ during the operating period 42. The control and/or regulating unit 26 in the continuous heating operating state 50 continuously operates the third induction target 32″ in the switched-on interval tₒₙ₁₁ of the operating period 42 in order to achieve the desired heating power 30″, P_{SOLL} of the third induction target 32 (cf. FIG. 5b).

Averaged over the operating period 42, the control of the three induction targets 32, 32′, 32″ for each induction target 32, 32′, 32″ provides the requested desired heating power 30, 30′, 30″ to each induction target 32, 32′, 32″ while avoiding intermodulation interfering noise. The operating period 42 corresponds to maximum half of the period duration of the alternating voltage supply 48, T_{HNETZ}, in particular mains alternating voltage. The operating period 42 in this example equals half of the period duration of the alternating voltage supply 48, T_{HNETZ}. Half of the period duration of the alternating voltage supply 48, T_{HNETZ} is illustrated in an exemplary manner in FIG. 5a. The control and/or regulating unit 26 is in particular provided so as in the continuous heating operating state 50 to select a sum of all the switched-on intervals 40, tₒₙ₁₁, tₒₙ₁₂, tₒₙ₁₃, tₒₙ₁₄, tₒₙ₁₅, tones of the operating period 42, in particular for each of the three induction targets 32, 32′, 32″ separately as a multiple of a reciprocal value of the heating current frequency 36.

The sum of all the switched-on intervals 40, in particular of an individual induction target 32, 32′, 32″ of the operating period 42 corresponds to maximum half of the period duration of the alternating voltage supply 48, T_{HNETZ}, in particular mains alternating voltage.

At the start and at the end of each operating period 42 an identical heating power is achieved by the control and/or regulating unit 26 in sum over all the induction targets 32, 32′, 32″ that are controlled.

It is conceivable that the operating period 42 corresponds to an integer factor of half of the period duration of the alternating voltage supply 48, T_{HNETZ}.

It is also conceivable that each induction target 32, 32′, 32″, 32′″ is controlled and/or must be controlled with another heating current frequency 36. In particular in that case, the control and/or regulating unit 26 is provided so as in the continuous heating operating state 50 to operate at least one inverter 64 per induction target 32, 32′, 32″, 32′″. A flicker is checked by the control and/or regulating unit 26 by the formation of the operating period 42 as an integer factor of half of the period duration of the alternating voltage supply 48, T_{HNETZ}. It is possible by the formation of the operating period 42 as an integer factor of half of the period duration of the alternating voltage supply 48, T_{HNETZ} to avoid a maximum power requirement of above 4.25 kW, preferably of above 3.7 kW, over a temporal limit of half of the period duration of the alternating voltage supply 48, T_{HNETZ}.

In each case, each induction target 32, 32′, 32″, 32′″ has a minimum frequency with which it is possible to control said induction target. In each case, each induction target 32, 32′, 32″, 32′″ has a maximum frequency with which it is possible to control said induction target.

In each case, each induction target 32, 32′, 32″, 32′″ can be controlled in such a manner that the same power is achieved at the beginning and end of each operating period 42, in particular over all the induction targets 32, 32′, 32″, 32′″ that are operated. In particular, it is possible to switch off a modulation for each induction target 32, 32′, 32″, 32′″, in particular a control, with the heating current frequency 36 within the operating period 42, in particular within the half of the period duration of the alternating voltage supply 48.

It is conceivable that the switched-on intervals 40 are embodied as distributed over the half of the period duration of the alternating voltage supply 48 by the control and/or regulating unit 26 for at least one induction target 32, 32′, 32″, 32′″. It is conceivable that the switched-on intervals 40 are embodied as distributed over the half of the period duration of the alternating voltage supply 48 by the control and/or regulating unit 26 for at least one induction target 32, 32′, 32″, 32′″, wherein these high frequency variations do not destabilize the mains supply voltage. It is conceivable that the switched-off intervals 36 are embodied as distributed over the half of the period duration of the alternating voltage supply 48, in particular over the operating period 42, by the control and/or regulating unit 26 for at least one induction target 32, 32′, 32″, 32′″, in particular in order to meet EMC standards. It is conceivable that the switched-off intervals 36 are embodied as distributed over half of the period duration of the alternating voltage supply 48, in particular over the operating period 42, by the control and/or regulating unit 26 for at least one induction target 32, 32′, 32″, 32′″, wherein a maximum power requirement of above 4.25 kW, preferably of above 3.7 kW or equivalent 16 Aᵣₘₛ, is avoided at the beginning or at the end of the half of the period duration of the alternating voltage supply 48.

It is conceivable that in an operating period 42 of a maximum 10 ms, a maximum 750 cycles of the heating current frequency 36 are applied to an induction target, in the case of a maximum heating current frequency 36 of 75 kHz. It is conceivable that in one operating period 42 of maximum 10 ms, minimum 300 cycles of the heating current frequency 36 are applied to an induction target, in the case of a minimum heating current frequency 36 of 30 kHz. In the prior art, in one operating period 42 of 2 s, between 200 and 240 cycles of the heating current frequency 36 are applied to an induction target.

FIG. 6 illustrates schematically a method for operating a cooking appliance device 10, in particular an induction hob device.

In at least one periodic continuous heating operating state 50, which is allocated at least one operating period 42, at least one induction target 32, 32′, 32″, 32′″ is repetitively controlled with a heating current frequency 36 and is supplied with energy.

In the at least one continuous heating operating state 50, the induction target 32, 32′, 32″, 32′″ is operated in at least one switched-on interval 40 of the operating period 42 with a heating power, in particular a desired heating power 30, 30′, 30″ or an excess power with respect to a desired heating power 30, 30′, 30″.

In the at least one continuous heating operating state 50, a sum of all the switched-on intervals 40 of the operating period 42 is selected as a multiple of a reciprocal value of the heating current frequency 36.

The at least one continuous heating operating state 50 comprises at least four part states, in particular at least one input state 52, at least one determining state 54, at least one control state 56 and at least one heating state 58. In the at least one input state 52, a desired heating power 30, 30′, 30″, P_{SOLL} is input by an operator for at least one induction target 32, 32′, 32″, 32′″.

In the at least one input state 52, the target frequency for the induction target 32, 32′, 32″, 32′″ is calculated, in particular from a desired heating power 30, 30′, 30″, P_{SOLL} that is set by the operator.

In the at least one determining state 54, in particular that adjoins the at least one input state 52, the target frequency of each induction target 32, 32′, 32″, 32′″ is matched with a maximum possible frequency, in particular a maximum frequency, of the at least one induction target 32, 32′, 32″, 32′″. In the at least one determining state 54, the target frequency of each induction target 32, 32′, 32″, 32′″ is matched with the target frequencies of each further induction target 32, 32′, 32″, 32′″ in order to avoid intermodulation interfering noise. In the at least one determining state 54, the heating current frequency 36 of each induction target 32, 32′, 32″, 32′″ is selected within the limits as approximate to the maximum frequency, in particular in order to avoid intermodulation interfering noise.

In the at least one control state 56, the switched-on intervals 40 and switched-off intervals 46 are selected for each induction target 32, 32′, 32″, 32′″ that is to output a desired heating power 30, 30′, 30″ in an operating period 42. In the at least one control state 56, the at least one switched-on interval 40 of each induction target 32, 32′, 32″, 32′″ are selected as a multiple of the reciprocal value of the heating current frequency 36, in particular of the maximum frequency of the induction target 32, 32′, 32″, 32′″ that is controlled. In the at least one control state 56, the sum of the switched-on interval 40 is selected for each induction target 32, 32′, 32″, 32′″ as a multiple of the reciprocal value of the heating current frequency 36, in particular the maximum frequency of the induction target 32, 32′, 32″, 32′″ that is controlled. It is conceivable that in the at least one control state 56, at least one switched-off interval 46, in particular a sum of the switched-off intervals 46, of an induction target 32, 32′, 32″, 32′″ is selected as a multiple of the reciprocal value of the heating current frequency 36, in particular the maximum frequency of the induction target 32, 32′, 32″, 32′″ that is controlled.

If a heating current frequency 36 that is selected for an induction target 32, 32′, 32″, 32′″ is lower than the target frequency that is determined for the respective induction target 32, 32′, 32″, 32′″, in the at least one control state 56, a switched-on interval 40 is selected for the respective induction target 32, 32′, 32″, 32′″ and said switched-on interval is shorter than the operating period 42.

If a heating current frequency 36 that is selected for an induction target 32, 32′, 32″, 32′″ is identical to the target frequency that is determined for the respective induction target 32, 32′, 32″, 32′″, in the at least one control state 56, the at least one switched-on interval 40 that is identical to the operating period 42 is selected for the respective induction target 32, 32′, 32″, 32′″.

In the at least one heating state 58, each induction target 32, 32′, 32″, 32′″ is operated over at least one operating period 42 with the selected switched-on and/or switched-off intervals 46 in order to provide the desired heating power 30, 30′, 30″, P_{SOLL} that is set.

In the at least one continuous heating operating state 50, the part states are repetitively cycled through, wherein parameters that are selected/calculated and/or determined in the part states are maintained in the absence of a desired heating power 30, 30′, 30″, P_{SOLL} that is changed by an operator for at least one induction target 32, 32′, 32″, 32′″.

### LIST OF REFERENCE CHARACTERS

10 Cooking appliance device
12 Hob
14 Item of cookware
16 Resting plate
18 Cooking zone
20 Cooking appliance
22 Inductor
24 Control panel
26 Control and/or regulating unit
28 Display
30 Desired heating power
32 Induction target
34 Output heating power
36 Heating current frequency
38 Inverter unit
40 Switched-on interval
42 Operating period
44 Resonance capacitor unit
46 Switched-off interval
48 Half of a period duration of an alternating voltage supply
50 Continuous heating operating state
52 Input state
54 Determining state
56 Control state
58 Heating state
60 Switch element
62 Relay
64 Inverter
66 Switched-on interval
68 Switched-on part interval
70 Abscissa
72 Ordinate
74 Abscissa
76 Ordinate
78 Ordinate

1-12. (canceled)

13. A cooking appliance device, comprising a control and/or regulating unit provided to repetitively control a first induction target with a first heating current frequency in a periodic continuous heating operating state, which is allocated an operating period, to supply the first induction target with energy, and to operate the first induction target in a switched-on interval of the operating period with a heating power, wherein the control and/or regulating unit is provided to select in the continuous heating operating state a sum of all switched-on intervals of the operating period as a multiple of a reciprocal value of the first heating current frequency.

14. The cooking appliance device of claim 13, constructed in the form of an induction hob device.

15. The cooking appliance device of claim 13, wherein the sum of all switched-on intervals of the operating period corresponds to maximum half of a period duration of an alternating voltage supply.

16. The cooking appliance device of claim 13, wherein the operating period corresponds to maximum half of a period duration of an alternating voltage supply.

17. The cooking appliance device of claim 13, wherein the operating period corresponds to an integer factor of half of a period duration of an alternating voltage supply.

18. The cooking appliance device of claim 13, wherein the control and/or regulating unit is provided to operate the first induction target in the continuous heating operating state in at least one further switched-on interval of the operating period with a heating power.

19. The cooking appliance device of claim 13, wherein the control and/or regulating unit is provided to continuously operate in the continuous heating operating state a second induction target during the operating period.

20. The cooking appliance device of claim 13, further comprising an inverter operably connected to the first induction target, said control and/or regulating unit operating the inverter in the continuous heating operating state.

21. The cooking appliance device of claim 13, wherein the control and/or regulating unit is provided to measure in the continuous heating operating state the heating power of the first induction target at least twice within half of a period duration of an alternating voltage supply.

22. The cooking appliance device of claim 13, wherein the control and/or regulating unit is provided to repetitively control in the continuous heating operating state a second induction target with a second heating current frequency, to supply the second induction target with energy, and to operate the second induction target in a second switched-on interval of the operating period with a heating power, wherein the second heating current frequency either essentially equals the first heating current frequency or differs from the first heating current frequency by at least 16 kHz, said control and/or regulating unit being provided to select in the continuous heating operating state a sum of all second switched-on intervals of the operating period as a multiple of a reciprocal value of the second heating current frequency.

23. The cooking appliance device of claim 13, wherein the control and/or regulating unit is provided to divide in the continuous heating operating state the switched-on interval of the first induction target in the operating period into at least two switched-on part intervals that are separated by at least one switched-off interval in which the first induction target is operated with a power deficit with respect to a desired heating power.

24. A cooking appliance, comprising a cooking appliance device, said cooking appliance device comprising a control and/or regulating unit provided to repetitively control an induction target with a heating current frequency in a periodic continuous heating operating state, which is allocated an operating period, to supply the induction target with energy, and to operate the induction target in a switched-on interval of the operating period with a heating power, wherein the control and/or regulating unit is provided to select in the continuous heating operating state a sum of all switched-on intervals of the operating period as a multiple of a reciprocal value of the heating current frequency.

25. The cooking appliance of claim 24, constructed in the form of a hob.

26. A method for operating a cooking appliance device, in particular an induction hob device, said method comprising:
repetitively controlling in a periodic continuous heating operating state, which is allocated at least one operating period, a first induction target with a first heating current frequency;
supplying the first induction target with energy;
operating the first induction target with a heating power in a switched-on interval of the operating period; and
selecting in the continuous heating operating state a sum of all switched-on intervals of the operating period as a multiple of a reciprocal value of the first heating current frequency.

27. The method of claim 26, further comprising operating the first induction target in the continuous heating operating state in a further switched-on interval of the operating period with a heating power.

28. The method of claim 26, further comprising continuously operating in the continuous heating operating state a second induction target during the operating period.

29. The method of claim 26, further comprising operating an inverter for the first induction target in the continuous heating operating state.

30. The method of claim 26, further comprising measuring in the continuous heating operating state the heating power of the first induction target at least twice within half of a period duration of an alternating voltage supply.

31. The method of claim 26, further comprising:
repetitively controlling in the continuous heating operating state a second induction target with a second heating current frequency which either essentially equals the first heating current frequency or differs from the first heating current frequency by at least 16 kHz;
supply the second induction target with energy;
operating the second induction target in a second switched-on interval of the operating period with a heating power; and
selecting in the continuous heating operating state a sum of all second switched-on intervals of the operating period as a multiple of a reciprocal value of the second heating current frequency.

32. The method of claim 26, further comprising dividing in the continuous heating operating state the switched-on interval of the first induction target in the operating period into at least two switched-on part intervals that are separated by at least one switched-off interval in which the first induction target is operated with a power deficit with respect to a desired heating power.
